(19) United States
(12) Patent Application Publication
(10) Pub. No.: US 2007/0184826 A1
(43) Pub. Date: Aug. 9, 2007

(54) Method for relaying in a cellular network and cellular mobile communication system supporting the same

(75) Inventors: Won-Hyoung Park, Seoul (KR); Dae-Young Park, Seoul (KR); Min-Kyu Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,236

(22) Filed: Jan. 9, 2007

(30) Foreign Application Priority Data
Jan. 9, 2006 (KR) 10-2005-0002186

(51) Int. Cl. H04Q 7/20

(52) U.S. Cl. 455/422.1; 455/11.1

(57) ABSTRACT

A method is disclosed for relaying data between a Base Station (BS) and a Mobile Station (MS) through a relay station in a cellular network. In the data relay method, the relay station receives data from the BS and the MS, performs network coding on first data received from the BS and second data received from the MS using a predefined operator, generates a packet with the network-coded data, and transmits the packet to the BS and the MS through one wireless channel. Identification information indicating the network coding, identification information of the MS, sizes of the first and second data, and sequence numbers of the first and second data are recorded in a header of the packet.

### PRIORITY

This application claims the benefit under 35 U.S.C. §119(a) of an application filed in the Korean Intellectual Property Office on Jan. 9, 2006 and assigned Serial No. 2006-2186, which is incorporated herein by reference.

### BACKGROUND OF THE INVENTION

1. Field of the Invention

The present invention relates generally to a method for relaying signals in a cellular network and a cellular mobile communication system supporting the same.

2. Description of the Related Art

Generally in a cellular network, a service area provided by a Base Station (BS) is fixed. In the cellular network, in order to extend the service area, it is general to additionally install BSs. However, the addition of BSs may cause an excessive increase in system cost. In addition, it is uneconomical to install a new BS in the area unless there are a sufficient number of users who receive service.

Therefore, research is being conducted to extend the service area without the need to install additional BSs. For example, there is a scheme for adding a relay station. This scheme relays signals between a BS and a Mobile Station (MS) through the added relay station. The relay station can be implemented with a separate device for relaying, or implemented in the MS.

FIG. 1 illustrates a conventional method of transmitting data via a relay station in a cellular network with a service area extended by an existing two-hop scheme. Referring to FIG. 1, reference numeral 110 denotes a service area defined by a BS 112 and a relay station 114. The BS 112 transmits a downlink signal X_{d} for delivery to an MS 116. The relay station 114 receives the downlink signal X_{d}, and transmits the received downlink signal X_{d} to the MS 116.

The MS 116 transmits an uplink signal Xᵤ having the BS 112 as its destination. The relay station 114 receives the uplink signal Xᵤ, and transmits the received uplink signal Xᵤ to the BS 112.

As described above, in the existing cellular network, when the relay station relays signals, it separately needs uplink/downlink resources between the BS and the relay station, and uplink/downlink resources between the relay station and the MS. That is, although using the scheme of adding a relay station to the existing cellular network can extend the service area, this scheme needs additional wireless resources.

Accordingly, there is a need for a method capable of efficiently using wireless resources in order to apply the relay station addition scheme to the cellular network.

### SUMMARY OF THE INVENTION

An aspect the present invention is to address at least the problems and/or disadvantages and to provide at least the advantages described below. Accordingly, an aspect of the present invention is to provide a scheme for reducing required wireless resources in a cellular network that relays data via a relay station.

Another aspect of the present invention is to provide a method for network-coding and transmitting data from a BS and data from an MS in a relay station of a cellular network.

Yet another aspect of the present invention is to provide a cellular mobile communication system in which a relay station network-codes and transmits data from a BS and data from an MS.

Another further aspect of the present invention is to provide a method for transmitting network-coding information as header information of a packet in a relay station of a cellular network, and a cellular mobile communication system supporting the same.

Still another aspect of the present invention is to provide a method for receiving, by a BS and an MS, network-coded data transmitted from a relay station in a cellular network, and a cellular mobile communication system supporting the same.

Still another aspect of the present invention is to provide a method for changing a size of data received from a BS or data received from an MS, for network coding in a relay station of a cellular network.

Still another aspect of the present invention is to provide a method for processing data received from a BS and data received from an MS and performing network coding on the processed data in a relay station of a cellular network.

Still another aspect of the present invention is to provide a method for interleaving at least one of data received from a BS and data received from an MS and performing network coding on the interleaved data in a relay station of a cellular network.

Still another aspect of the present invention is to provide a method in which a BS and an MS receive the data interleaved and network-coded by a relay station of a cellular network, and a cellular mobile communication system supporting the same.

According to one aspect of the present invention, there is provided a method for relaying data between a BS and an MS through a relay station in a cellular network. In the data relay method, the relay station receives data from the BS and the MS, performs network coding on first data received from the BS and second data received from the MS using a predefined operator, generates a packet with the network-coded data, and transmits the packet to the BS and the MS through one wireless channel. Identification information indicating the network coding, identification information of the MS, sizes of the first and second data, and sequence numbers of the first and second data are recorded in a header of the packet.

Preferably, if the size of the first data is not identical to the size of the second data, the relay station pads zeros (‘0’s) to smaller-sized data or codes the smaller-sized data at a predefined coding rate so that the size of the first data is identical to the size of the second data.

It is also preferable that the relay station interleaves at least one of the first data and the second data according to a predefined interleaving pattern before performing the network coding.

Preferably, the relay station decodes the first data or the second data as it is, if there is no first or second data on which the network coding is to be performed.

According to another aspect of the present invention, there is provided a method for receiving transmitted data via a relay station by a receiving station in a cellular network. The data receiving method includes receiving a packet from the relay station; determining whether the packet was network-coded, depending on header information of the received packet; and if the packet was network-coded, performing network decoding on the received packet and its transmission first data through an operation of a predefined operator thereby outputting second data. Identification information indicating the network coding, identification information of the receiving station, sizes of the first and second data, and sequence numbers of the first and second data are recorded in a header of the packet.

According to further another aspect of the present invention, there is provided a cellular mobile communication system including a relay station for performing network coding on first data received from a BS and second data received from an MS through an operation of a predefined operator, generating a packet composed of a header and a payload, and transmitting the packet to the BS and the MS through one wireless channel, wherein identification information indicating the network coding, identification information of the MS, sizes of the first and second data, and sequence numbers of the first and second data are recorded in the header, and the payload includes the network-coded data; the BS for determining whether the packet was network-coded, based on the identification information recorded in the header of the packet received from the relay station, and if the packet was network-coded, performing network decoding on the data corresponding to the payload of the received packet and its transmission first data through an operation of a predefined operator, thereby outputting second data; and the MS for determining whether the packet was network-coded, based on the identification information recorded in the header of the packet received from the relay station, and if the packet was network-coded, performing network decoding on the data corresponding to the payload of the received data and its transmission second data through an operation of a predefined operator, thereby outputting first data.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional method for transmitting data via a relay station in a cellular network with a service area extended by an existing two-hop scheme;

FIG. 2 illustrates data transmission via a relay station in a cellular network according to the present invention;

FIG. 3 is a flowchart illustrating a procedure for relaying data in a relay station of a cellular network according to the present invention;

FIG. 4 is a flowchart illustrating a subroutine performed for network coding in a relay station according to the present invention;

FIG. 5 is a flowchart illustrating a procedure for receiving data in a BS and/or an MS according to the present invention;

FIG. 6 illustrates a structure for network coding in a relay station according to the present invention;

FIG. 7 illustrates a structure for network decoding in a BS according to the present invention; and

FIG. 8 illustrates a structure for network decoding in an MS according to the present invention.

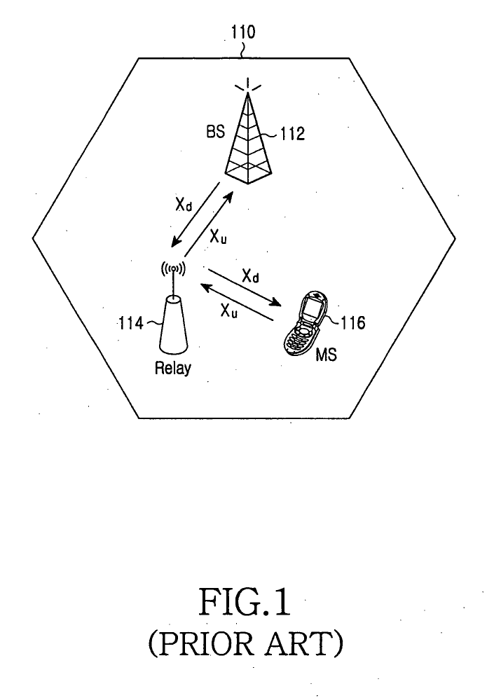

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness. In the drawings, the same reference numerals refer to the same elements, features and structures.

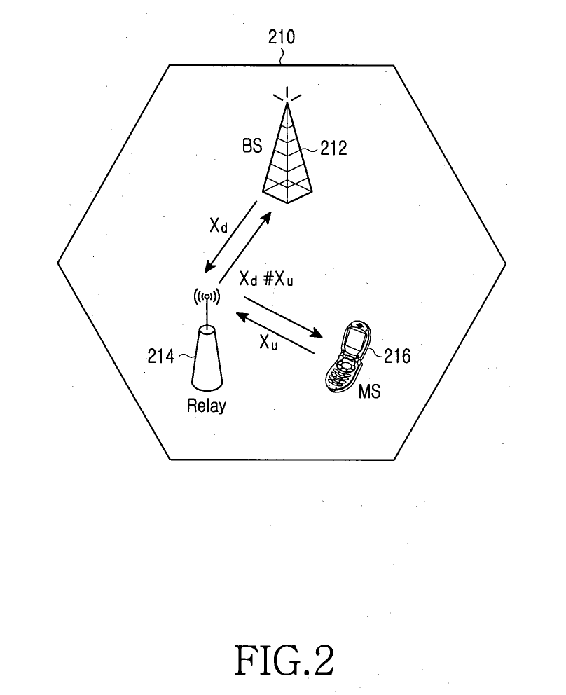

With reference to FIG. 2, a description is provided of a method for transmitting data via a relay station in a cellular network with a service area extended by a two-hop scheme according to the present invention. In FIG. 2, relay station 214 receives a downlink signal X_{d} from BS 212 and an uplink signal Xᵤ from MS 216. The relay station 214 temporarily stores the downlink signal X_{d} and the uplink signal Xᵤ in the received order. The relay station 214 generates new data by applying network coding to the downlink signal X_{d} and the uplink signal Xᵤ.

The network coding is performed by an operation with a predefined operator. In FIG. 2, the operator is denoted by the ‘#’ symbol. The operator is defined such that if one of the downlink signal X_{d} and the uplink signal Xᵤ is known, the other signal can be found. An eXclusive OR (XOR) operator is an example of the operator.

The relay station 214 transmits a network-coded signal ‘X_{d} # Xᵤ’ through one wireless channel. That is, the relay station 214 transmits the signal ‘X_{d} # Xᵤ’ using wireless resources that can be shared by the BS 212 and the MS 216. Therefore, the new method can transmit signals with fewer wireless resources, compared with the existing method in which than the wireless resources are separately allocated for transmitting signals to a BS and an MS.

The BS 212 and the MS 216 receive the network-coded signal from the relay station 214, and perform network-decoding on the received network-coded signal, thereby obtaining desired signals. The BS 212 uses its transmitted downlink signal X_{d} for the network decoding, and the MS 216 uses its transmitted uplink signal Xᵤ for the network decoding.

Herein, an operator for the network decoding will be denoted by ‘%’. If an XOR operator is used for the network coding, an XOR operator can be used for the network decoding. Therefore, the network decoding that the BS 212 performs to obtain Xᵤ can be expressed as ‘(X_{d} # Xᵤ) % X_{d}’, and the network decoding that the MS 216 performs to obtain X_{d} can be expressed as ‘(X_{d} # Xᵤ) % Xᵤ’. If the network coding is performed with an XOR operator, the operators ‘#’ and ‘%’ should be replaced with ‘⊕’ indicating an XOR operator.

A. Transmission Operation

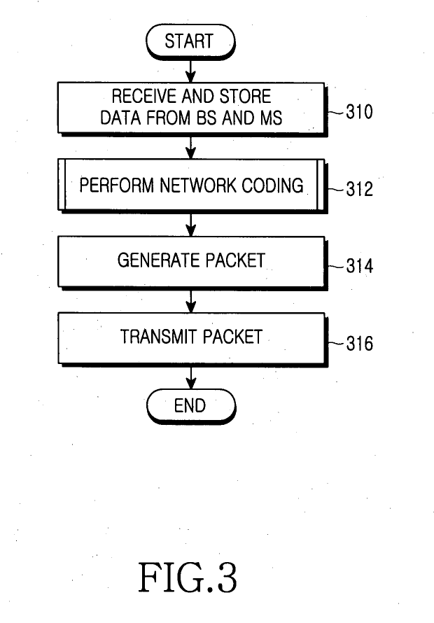

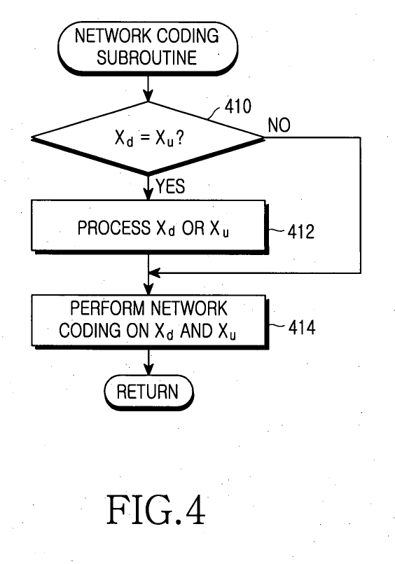

With reference to FIGS. 3 and 4, a description is provided of an operator of relaying signals in a relay station of a cellular network according to the present invention.

In step 310, a relay station receives a downlink signal X_{d} from a BS and an uplink signal Xᵤ from an MS, and stores the received downlink signal X_{d} and uplink signal Xᵤ. Preferably, step 310 should be constantly performed even while its succeeding procedure is performed by the relay station.

In step 312, the relay station performs network coding. The network coding includes operating the downlink signal X_{d} and the uplink signal Xᵤ with a predefined operator. For example, the network coding is performed by XORing the downlink signal X_{d} and the uplink signal Xᵤ. A detailed description of the network coding is provided with reference to FIG. 4.

However, in the network coding process, it is possible that a corresponding signal does not exist. For example, where even though a downlink signal X_{d} is received from the BS, an uplink signal Xᵤ is not received from the MS, and vice versa.

In this case, the relay station does not perform network coding, or can perform network coding using a predetermined signal. In the former case where network coding is not performed, the relay station transmits the downlink signal X_{d} or the uplink signal Xᵤ as it is. However, in the latter case where network coding is performed, the relay station network-codes the downlink signal X_{d} or the uplink signal Xᵤ with a predetermined signal, before transmission.

If the network coding is completed, the relay station generates a packet in step 314. The relay station can generate the packet by combining a payload with a header. The payload corresponds to the network-coded signal, and the header is generated with information (“header information” herein) on the downlink signal X_{d} and the uplink signal Xᵤ.

The header information includes first identification information indicating execution/non-execution of network coding, second identification information used for identifying an MS that will receive a corresponding packet, and size and sequence number for each of X_{d} and Xᵤ. The BS should receive all packets transmitted from the relay station. Therefore, the header information does not include identification information used for identifying the BS.

The first identification information is used by the BS or the MS for determining whether network coding was performed on the received packet. The second identification information is used by the MS for identifying its desired packet. The second identification information may include an address of the MS, or a separate IDentifier (ID). The size information of the X_{d} and Xᵤ, when the X_{d} and Xᵤ are processed for network coding, is used for restoring the processed X_{d} and Xᵤ. The sequence number for each of the X_{d} and Xᵤ is used by the BS or the MS for determining a signal to be used for performing network decoding, among its transmission signals.

In addition, when Cyclic Redundancy Check (CRC) based error correction is used, the relay station should add, to the header information, a CRC value before each of the downlink signal X_{d} and the uplink signal Xᵤ. This allows both the BS and MS receiving the packet to perform the CRC check. Therefore, the header should include fields for recording the header information.

In step 316, the relay station transmits the generated packet. The packet is transmitted through a wireless channel that uses wireless resources sharable by the BS and the MS.

FIG. 4 is a flowchart illustrating a subroutine performed for network coding in the relay station. Referring to FIG. 4, for network coding, it is preferable to map the downlink signal X_{d} and the uplink signal Xᵤ in terms of the size. For this purpose, the BS and the MS may agree to transmit data with a predetermined size.

In step 410, the relay station determines whether the downlink signal X_{d} and the uplink signal Xᵤ are identical in size. If the downlink signal X_{d} and the uplink signal Xᵤ are not identical in size, the relay station matches the size of the downlink signal X_{d} to the size of the uplink signal Xᵤ in step 412.

A scheme for matching the size of the downlink signal X_{d} to the size of the uplink signal Xᵤ can be implemented in various ways. The simplest scheme is to pad zeros (‘0’) to a part of the smaller-sized data. Another scheme is to repeat some bits of the smaller-sized data. Yet another scheme is to code at least one of the downlink signal X_{d} and the uplink signal Xᵤ at a predetermined coding rate. The coding used herein is different from the network coding. For the coding rate, a coding rate for the smaller-sized data is determined, considering the larger-sized data.

If the sizes are matched by the coding rate, the coding rate used for coding at least one of the downlink signal X_{d} and the uplink signal Xᵤ is recorded as header information. In this case, the size information of the downlink signal X_{d} and the uplink signal Xᵤ can be omitted from the header information.

If the downlink signal X_{d} and the uplink signal Xᵤ are identical in size in the above-described method, the relay station performs a network coding operation in step 414. As described above, the typical network coding operation is an operation of XORing the downlink signal X_{d} and the uplink signal Xᵤ on a bit-by-bit basis.

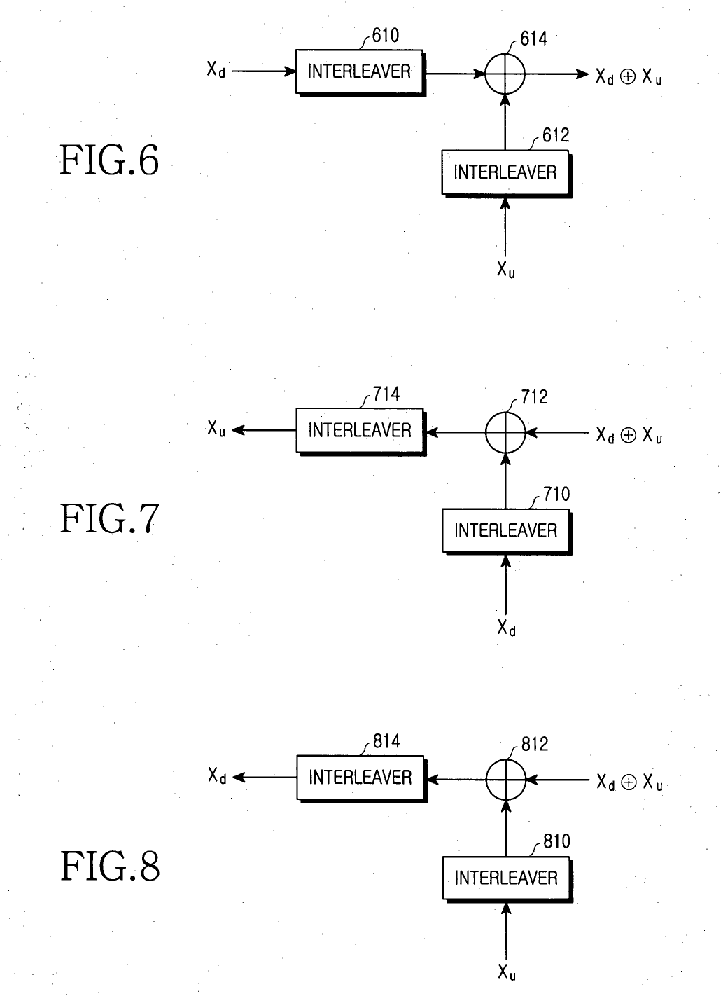

FIG. 6 illustrates a structure for network coding in a relay station according to the present invention. In FIG. 6, interleavers are used as an exemplary entity for processing data before network coding. Referring to FIG. 6, a downlink signal X_{d} received from a BS is interleaved by a first interleaver 610 according to a predetermined pattern, and an uplink signal Xᵤ received from an MS is interleaved by a second interleaver 612 according to a predetermined pattern. The interleaving pattern used in the first interleaver 610 and the interleaving pattern used in the second interleaver 612 can be either identical to or different from each other.

The downlink signal X_{d} interleaved by the first interleaver 610 and the uplink signal Xᵤ interleaved by the second interleaver 612 are XORed by an XOR operator 614 on a bit-by-bit basis, generating network-coded data ‘X_{d}⊕Xᵤ’.

B. Reception Operation

B-1. Reception Operation of BS

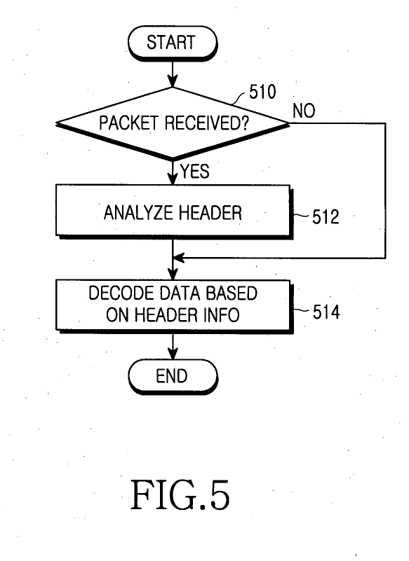

With reference to FIG. 5, a description will now be made of an operation of receiving data in a BS according to the present invention. In step 510, a BS monitors whether a packet is received from a relay station. Upon receipt of a packet, the BS analyzes header information of the received packet in step 512. The header information is the same as described above.

In step 514, the BS performs network decoding on a payload of the packet depending on the header information. The network decoding is performed only when it is determined that the packet was network-coded, based on identification information recorded in the header information. If the packet was not network-coded, step 514 can be omitted.

For the network decoding, the BS performs a predetermined operation on the data provided through the packet and its transmitted data, and the network decoding can be expressed as ‘(X_{d} # Xᵤ) % X_{d}’. The ‘X_{d} # Xᵤ’ indicates the data provided through the packet, i.e. the network-coded data, and the ‘X_{d}’ indicates the data transmitted by the BS. For example, if an XOR operator was used as an operator for the network coding, the network decoding can be expressed as ‘(X_{d}⊕Xᵤ)⊕X_{d}’. The ‘X_{d}⊕Xᵤ’ indicates the data provided through the packet, i.e. the network-coded data, and the ‘X_{d}’ indicates the data transmitted by the BS.

The BS acquires the data Xᵤ transmitted from the MS, through network decoding. However, if the data provided through the packet was processed before being network-coded, the BS should re-process the data acquired by the network decoding. As described above, the relay station can perform data processing for matching the sizes of the downlink signal X_{d} and the uplink signal Xᵤ.

If the data processing was performed by the zero (‘0’) padding scheme, the BS re-processes the acquired uplink signal Xᵤ taking into account the size of the uplink signal Xᵤ, provided as header information. That is, the BS removes the zeros (‘0’s) inserted by the relay station. Otherwise, if the data processing was performed by the coding scheme, the BS re-processes the acquired uplink signal Xᵤ at a coding rate of the uplink signal Xᵤ, provided as header information. That is, the BS decodes the acquired uplink signal Xᵤ at the coding rate.

Although omitted in FIG. 5, it will be recognized from the above description that the BS can perform CRC check on the acquired uplink signal Xᵤ. Based on the CRC check result, the BS can determine if it has normally received the data that the MS has desired to transmit.

FIG. 7 illustrates a structure for network decoding in a BS according to the present invention. In FIG. 7, it is assumed that the downlink signal X_{d} and the uplink signal Xᵤ are processed by interleavers.

Referring to FIG. 7, a transmission downlink signal X_{d} of the BS is interleaved by a first interleaver 710 according a predetermined interleaving pattern. The downlink signal X_{d} interleaved by the first interleaver 710 and data ‘X_{d}⊕Xᵤ’ received from a relay station are XORed by an XOR operator 712 on a bit-by-bit basis, generating network-decoded data. The output data of the XOR operator 712 is an interleaved uplink signal Xᵤ.

The interleaved uplink signal Xᵤ is interleaved by a second interleaver 714 according to a predetermined interleaving pattern. The interleaving pattern used in the second interleaver 714 can be either identical to or different from the interleaving pattern used in the first interleaver 710. The output data of the second interleaver 714 is the uplink signal Xᵤ transmitted from the MS.

B-2. Reception Operation of MS

With reference to FIG. 5, a description will now be made of an operation of receiving data in an MS according to the present invention. In step 510, an MS monitors whether a packet is received from a relay station. Upon receipt of a packet, the MS analyzes header information of the received packet in step 512. The header information is the same as described above. The MS determines if the received packet is its desired data, based on identification information recorded in the header information.

If the received packet is its desired data, the MS performs, in step 514, network decoding on a payload of the packet depending on the header information. The network decoding is performed only when it is determined that the packet was network-coded, based on identification information recorded in the header information. If the packet was not network-coded, step 514 can be omitted.

For the network decoding, the MS performs a predetermined operation on the data provided through the packet and its transmitted data, and the network decoding can be expressed as ‘(X_{d} # Xᵤ) % Xᵤ’. The ‘X_{d} # Xᵤ’ indicates the data provided through the packet, i.e. the network-coded data, and the ‘Xᵤ’ indicates the data transmitted by the MS. For example, if an XOR operator was used as an operator for the network coding, the network decoding can be expressed as ‘(X_{d}⊕Xᵤ)⊕Xᵤ’. The ‘X_{d}⊕Xᵤ’ indicates the data provided through the packet, i.e. the network-coded data, and the ‘Xᵤ’ indicates the data transmitted by the MS.

The MS acquires the data X_{d} transmitted from the BS, through network decoding. However, if the data provided through the packet was processed before being network-coded, the MS should re-process the data acquired by the network decoding. As described above, the relay station can perform data processing for matching the sizes of the downlink signal X_{d} and the uplink signal Xᵤ.

If the data processing was performed by the zero (1 0’) padding scheme, the MS re-processes the acquired downlink signal X_{d} taking into account the size of the downlink signal X_{d}, provided as header information. That is, the MS removes the zeros (‘0’s) inserted by the relay station. Otherwise, if the data processing was performed by the coding scheme, the MS re-processes the acquired downlink signal X_{d} at a coding rate of the downlink signal X_{d}, provided as header information. That is, the MS decodes the acquired downlink signal X_{d} at the coding rate.

Although omitted in FIG. 5, it will be recognized from the above description that the MS can perform CRC check on the acquired downlink signal X_{d}. Based on the CRC check result, the MS can determine if it has normally received the data that the BS has desired to transmit.

FIG. 8 is a diagram illustrating a structure for network decoding in an MS according to the present invention. In FIG. 8, it is assumed that the downlink signal X_{d} and the uplink signal Xᵤ are processed by interleavers.

Referring to FIG. 8, a transmission uplink signal Xᵤ of the MS is interleaved by a first interleaver 810 according a predetermined interleaving pattern. The uplink signal Xᵤ interleaved by the first interleaver 810 and data ‘X_{d}⊕Xᵤ’ received from a relay station are XORed by an XOR operator 812 on a bit-by-bit basis, generating network-decoded data. The output data of the XOR operator 812 is an interleaved downlink signal X_{d}.

The interleaved downlink signal X_{d} is interleaved by a second interleaver 814 according to a predetermined interleaving pattern. The interleaving pattern used in the second interleaver 814 can be either identical to or different from the interleaving pattern used in the first interleaver 810. The output data of the second interleaver 814 is the downlink signal X_{d} transmitted from the BS.

The above-described operation applies to an easily-implementable two-hop scheme out of the multi-hop schemes. However, it would be obvious to those skilled in the art that the present invention can be applied to any cellular network employing two or more hops. In this case, the only difference between the two-hop scheme and other multi-hop scheme lies in that the transmission operation and the reception operation are simultaneously performed in the relay station for relaying data between a BS and a relay station, between a relay station and a relay station, or between a relay station and an MS.

As can be understood from the foregoing description, the present invention prepares a protocol scheme capable of allowing a relay station to perform network coding in a cellular mobile communication system that relays data through the relay station. As a result, it is possible to reduce wireless resources required for transmitting data through the relay station in the cellular mobile communication system.

While the invention has been shown and described with reference to certain preferred embodiments thereof, it will be understood by those skilled in the art that various changes in form and details may be made therein without departing from the spirit and scope of the invention, as defined by the appended claims.

What is claimed is:

1. A method for relaying data between a Base Station (BS) and a Mobile Station (MS) through a relay station in a cellular network, the method comprising:
the relay station receiving data from the BS and the MS;
performing network coding on first data received from the BS and second data received from the MS using a predefined operator;
generating a packet with the network-coded data; and
transmitting the packet to the BS and the MS through one wireless channel;
wherein identification information indicating the network coding, identification information of the MS, sizes of the first and second data, and sequence numbers of the first and second data are recorded in a header of the packet.

2. The method of claim 1, wherein if the size of the first data is not identical to the size of the second data, zeros are padded to smaller-sized data so that the size of the first data is identical to the size of the second data.

3. The method of claim 1, wherein if the sizes of the first and second data are not identical, smaller-sized data is coded at a predefined coding rate so that the size of the first data is identical to the size of the second data.

4. The method of claim 1, wherein if the sizes of the first and second data are not identical, predetermined bits of smaller-sized data are repeated so that the size of the first data is identical to the size of the second data.

5. The method of claim 3, wherein the predefined coding rate is recorded in a header of the packet.

6. The method of claim 4, wherein information on the repeated bits is recorded in a header of the packet.

7. The method of claim 1, further comprising interleaving at least one of the first data and the second data according to a predefined interleaving pattern before performing the network coding.

8. The method of claim 3, wherein the predefined operator is an eXclusive OR (XOR) operator.

9. The method of claim 1, wherein, if there first data on which the network coding is to be performed does not exist, the second data is transmitted to the BS.

10. The method of claim 10, wherein if second data on which the network coding is to be performed does not exist, the first data is transmitted to the MS.

11. A method for receiving transmitted data via a relay station by a receiving station in a cellular network, the method comprising:
receiving a packet from the relay station;
determining whether the packet was network-coded, depending on header information of the received packet; and
if the packet was network-coded, performing network decoding on the received packet and its transmission first data through an operation of a predefined operator thereby outputting second data;
wherein identification information indicating the network coding, identification information of the receiving station, sizes of the first and second data, and sequence numbers of the first and second data are recorded in a header of the packet.

12. The method of claim 11, further comprising removing zeros padded to the output second data according to the size of the second data.

13. The method of claim 11, wherein a coding rate is recorded in the header, and the output second data is restored at the coding rate.

14. The method of claim 11, wherein information on repeated bits is recorded in the header, and the output second data is restored according to the information on the repeated bits.

15. The method of claim 11, wherein the first data is interleaved according to a predefined interleaving pattern before being network-decoded.

16. The method of claim 15, wherein the output second data is interleaved according to a predefined interleaving pattern.

17. The method of claim 11, wherein the predefined operator is an exclusive OR (XOR) operator.

18. A cellular mobile communication system comprising:
a relay station for performing network coding on first data received from a Base Station (BS) and second data received from a Mobile Station (MS) through an operation of a predefined operator, generating a packet composed of a header and a payload, and transmitting the packet to the BS and the MS through one wireless channel, wherein identification information indicating the network coding, identification information of the MS, sizes of the first and second data, and sequence numbers of the first and second data are recorded in the header, and the payload includes the network-coded data;
the BS for determining whether the packet was network-coded, based on the identification information recorded in the header of the packet received from the relay station, and if the packet was network-coded, performing network decoding on the data corresponding to the payload of the received packet and transmission first data through an operation of a predefined operator, thereby outputting second data; and
the MS for determining whether the packet was network-coded, based on the identification information recorded in the header of the packet received from the relay station, and if the packet was network-coded, performing network decoding on the data corresponding to the payload of the received data and transmission second data through an operation of a predefined operator, thereby outputting first data.

19. The cellular mobile communication system of claim 18, wherein if the size of the first data is not identical to the size of the second data, the relay station pads zeros to smaller-sized data, or codes the smaller-sized data at a predefined coding rate so that the size of the first data is identical to the size of the second data.

20. The cellular mobile communication system of claim 18, wherein the relay station interleaves at least one of the first data and the second data according to a predefined interleaving pattern before performing the network coding.

21. The cellular mobile communication system of claim 18, wherein the predefined operator is an exclusive OR (XOR) operator.
